(19) United States
(12) Patent Application Publication
(10) Pub. No.: US 2009/0299577 A1
(43) Pub. Date: Dec. 3, 2009

(54) External Seatbelt Usage Indication System and Method

(76) Inventor: Istvan Demant, Niagara Falls (CA)

Correspondence Address: ISTVAN DEMANT, 7151 BRYANNE COURT, NIAGARA FALLS, ONTARIO, L2H 3L4, CA

(21) Appl. No.: 12/131,490

(22) Filed: Jun. 2, 2008

(51) Int. Cl. B60R 22/48

(52) U.S. Cl. 701/45; 180/268

(57) ABSTRACT

An external seatbelt usage indication system and method indicates whether or not the driver and passengers of a motor vehicle are wearing a seatbelt. It provides an indication of non-usage on the exterior of the motor vehicle using existing external lights on the vehicle so that it cannot be defeated by removal of the external indicator or bulbs associated with it. Upon activation of the vehicle ignition, occupant sensors and seatbelt usage sensors are used to determine a non-usage condition, upon which external lights of the vehicle are intermittently activated until the non-usage condition ceases.

### BACKGROUND

Embodiments disclosed herein are drawn to an external seatbelt usage indication system and method that indicates whether or not the driver and passengers of a motor vehicle are wearing a seatbelt. It provides an indication of non-usage on the exterior of the motor vehicle using existing external lights on the vehicle.

Due to educational awareness programs and state laws, most people today automatically buckle-up their seatbelts upon entering a motor vehicle. Such use has undoubtedly led to the saving of countless lives. However, there are still those who do not wear a seatbelt. While the reasons are many, most involve the fact that people forget, the chime warning is easy to ignore or defeat, they just simply don't want to use their seatbelt, or they are unaware of the non-use of seatbelts by other occupants, such as those in third-row seats. All of these reasons allow people to break the law, and cause insurance rates to be higher for all of the other drivers that comply with seatbelt laws.

While many states have enacted legislation requiring seat belt usage, it is difficult to enforce, as it is difficult to see in vehicles, especially at night. Thus, as it is easy to break the law, many do it because it is simply unlikely they will ever get caught. Accordingly, there is a need for a means by which seatbelt use can be enforced.

Prior art attempts have been made for external indication of seatbelt usage. U.S. Pat. No. 7,271,712 to Rubel, U.S. Pat. No. 7,283,043 to Harrison, U.S. Pat. No. 6,215,395 to Slaughter et al., U.S. Pat. No. 6,545,597 to Blount, and U.S. Pat. No. 5,714,930 to McKinney, Jr. rely upon the use of additional external indicator lights that involve additional cost, yet are subject to easy deactivation by bulb removal from the indicator lights. These systems also involve indicators that can negatively alter the aesthetics of the motor vehicle.

### BRIEF SUMMARY

Disclosed embodiments provide an external seatbelt usage indication system and method that indicates whether or not the driver and passengers of a motor vehicle are wearing a seatbelt. When a vehicle is in operation (i.e., the ignition is on), a processor senses the presence of an occupant and whether the occupant is using their seatbelt. Upon a condition of non-usage, the external lights (headlights and/or taillights) of the vehicle are operated intermittently (e.g., flashed, alternated, etc.) to give an external indication of seatbelt usage (or, more accurately, non-usage). Upon compliance by use of seatbelt(s), the intermittent operation of the vehicle lights ceases.

Embodiments provide an indication of non-usage on the exterior of the motor vehicle using existing external lights on the vehicle. Upon initial observation of a motor vehicle equipped with an embodiment, nothing appears recognizably different. However, when a driver sits in the driver's seat, activates the ignition, and does not apply the seatbelt, external lights (headlights and/or taillights) of the vehicle are intermittently operated. This same procedure also applies to any passengers in any of the vehicle occupant positions.

When the user fastens his or her seatbelt, the intermittent operation of the external vehicle lights ceases. Embodiments are envisioned to not only make it easier for law enforcement personnel to spot those breaking seat belt laws, but also to serve as an incentive for all to wear seat belts. The use of an external seatbelt usage indication system and method helps to ensure that more motor vehicle drivers and passengers wear their seatbelt at all times; and thus, serves to save more lives.

Various embodiments of the seatbelt usage indication system and method have many features that make it beneficial to both consumers and potential manufacturers. In addition to allowing Law Enforcement personnel to readily determine compliance with seatbelt laws, the various embodiments encourage seatbelt use to increase driver and passenger safety, reduce vehicular injuries and deaths, and lower insurance rates. By using existing external vehicle lights, the system and method is easier and cheaper to implement (whether during original manufacture or later), does not alter the aesthetics of the vehicle, is tamper resistant (since the lights are needed for other purposes), and can be retrofit to existing vehicles.

Many existing vehicles already have occupant sensors in the seating positions as part of a passive restraint system (i.e., airbags and side curtains) and seatbelt usage sensors (associated with a dashboard seatbelt indicator) that can be employed by the present system and method. The existing headlights and taillights can be seen during daylight or night driving and are easily seen from a distance. Intermittent operation of headlights and/or the running lamps of the taillights does not interfere with the ordinary operation of vehicle brake lamps. Since many emergency vehicles (police, fire, ambulance) use intermittent operation of headlights, other drivers are accustomed to moving out of the way and avoiding vehicles when their lights are flashing, which may also assist in keeping those in a non-compliant vehicles safer when using the disclosed external seatbelt usage indication system and method.

Further, when an oncoming vehicle encounters a non-compliant vehicle with flashing lights, the oncoming driver may also reciprocate with a flashing of his/her lights in reaction, thereby further addressing the non-compliant driver of his/her status.

### BRIEF DESCRIPTION OF THE DRAWINGS

FIG. 1 illustrates an embodiment of an external seatbelt usage indication system; and

FIG. 2 illustrates an embodiment of an external seatbelt usage indication method.

### DETAILED DESCRIPTION OF THE INVENTION

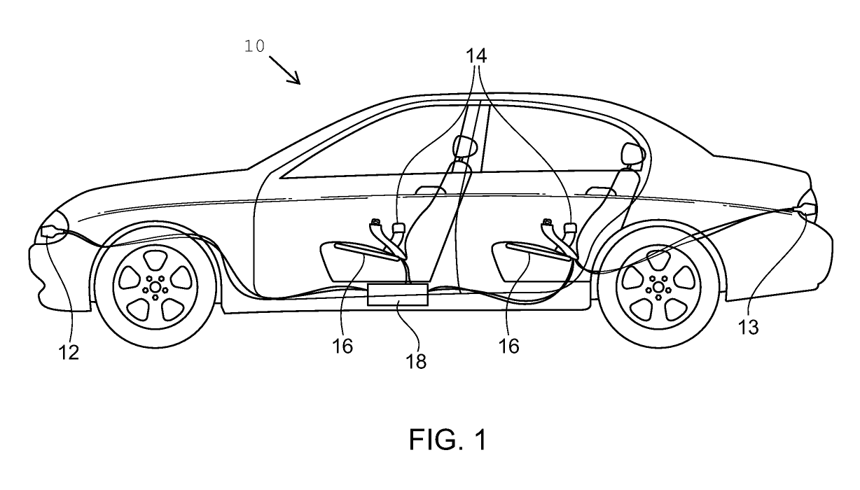

One embodiment is illustrated in FIG. 1, which shows a vehicle 10 with an external seatbelt usage indication system. Such a system can be installed during the original manufacturing of the vehicle or retrofitted at a later time, such as from a kit of components. Occupant sensors 16 and seatbelt (usage) sensors 14 are connected to a CPU or processor 18. The occupant sensors 16 are illustrated as weight sensors, but can be any other sensor suitable for detecting the presence of a person in the seating location, including but not limited to pressure sensors, ultrasonic/proximity sensors, light/laser sensors, heat/IR sensors, vision/motion sensors, and acoustic sensors. Seatbelt sensors 14 can be any suitable sensor for determining whether a seatbelt is being used. A simple limit switch (mechanical, magnetic, etc.) activated by a properly-latched seatbelt is one possible sensor, but many others can be used, including but not limited to vision sensors, proximity sensors, and RF (e.g., RFID) sensors. While wires are illustrated for connecting the sensors 14 and 16 to the processor 18, wireless connections are also possible and anticipated.

The processor 18 can be a dedicated processor, a general purpose processor, an ASIC, a microcontroller, or a simple electrical circuit. Such processors, controllers and circuits for monitoring a condition are known in the art for determining seatbelt use and/or for determining the presence of an occupant for airbag use. Modifying such systems for detection of two conditions involves mere skills of a technician.

In use, the processor 18 is powered upon operation of the vehicle ignition (not shown) and the presence of occupants is detected by occupant sensors 16. If an occupant is detected for a seating position, the processor checks the seatbelt sensor 14 to determine if the seatbelt is in use. If the processor 18 determines a condition of non-usage in an occupied seating position, the processor 18 operates a headlight interface 12 to cause an intermittent operation of the headlights. The intermittent operation can take any form that gives external notice to others, including but not limited to constant flashing, periodic flashing, alternate flashing of left and right headlights, or alternate flashing of highbeams and lowbeams on the headlights. The processor 18 can also operate a taillight interface 13 to cause an intermittent operation of the taillights, where intermittent operation can again take any form that gives external notice to others, including but not limited to constant flashing, periodic flashing, alternate flashing of left and right taillights, or alternate flashing of running lights and brake lights on the headlights (with operation of the brake lights during braking overtaking any operation of the brake lights by the processor 18).

As can be seen in FIG. 1, the external appearance of the vehicle 10 remains unchanged and the processor 18, wiring, and interfaces 12, 13 can be located in non-accessible areas to help prevent tampering with the system. The components of the system can be included during original manufacture of the vehicle or retrofitted at a later time.

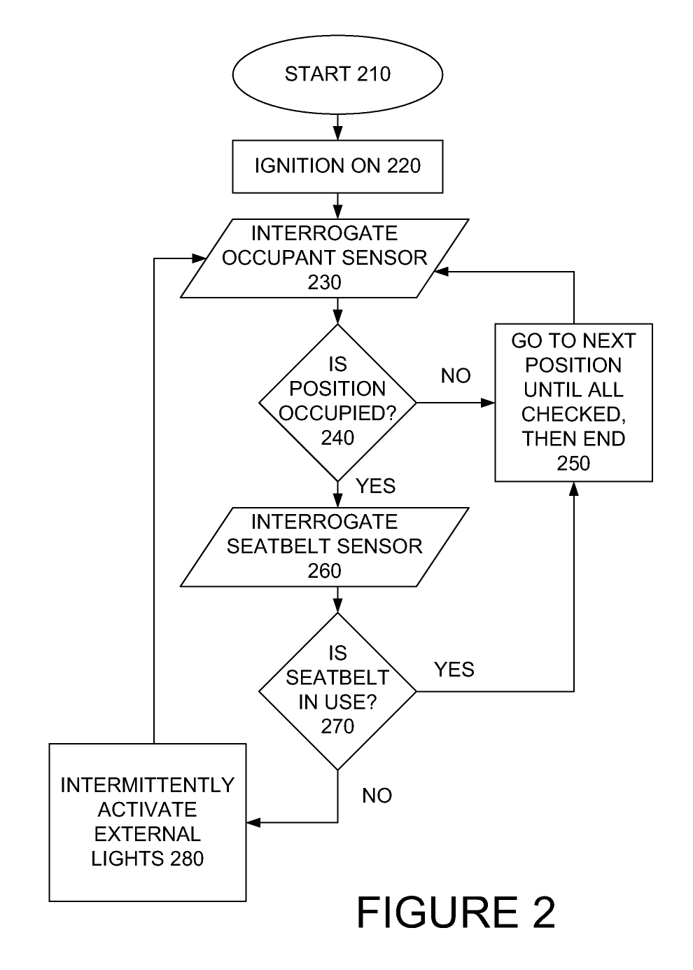

FIG. 2 illustrates a flow chart for an embodiment of an external seatbelt usage indication method. The method or process typically starts 210 when the ignition of the vehicle is turned on. However, as keyless vehicle systems that rely on the presence of a fob for operation are adopted, the presence of a driver and use of a pedal may become a substitute for the use of an ignition switch. Regardless, when a vehicle is ready for use and powered, it can be considered to have its ignition on 220 so as to power an components used by the process. In such a state, the process interrogates a first occupant sensor at 230 and determines whether the position if occupied at 240.

If the position is not occupied at 240, then the process interrogates the next position occupant sensor at 220 until all occupant positions are checked, at 250. If the position is occupied at 240, then the process interrogates the seatbelt sensor associated with the position at 260. If the seatbelt is in use at 270, then the process interrogates the next position occupant sensor at 220 until all occupant positions are checked, at 250. If the seatbelt is not in use at 270, then the process intermittently activates the external lights at 280 and starts the process over again to determine a change in status until it is determined that all seating positions occupied have their seatbelts in use.

While the process has been described as interrogating the various sensors, what is involved in interrogating the sensor can vary depending on the sensor and processor used. If the sensors used are merely limit switches used to close a circuit, then interrogating the sensor will comprise detection of an open or closed circuit. If the processor is a circuit, then interrogating the sensor is merely receiving the input (i.e., voltage, current, etc.) from the sensors. If the sensor is more complicated or wireless, then the interrogation can be a polling of the sensor and an acknowledgement signal from the sensor.

One embodiment is to an external seatbelt usage indication system for a motor vehicle, comprising a processor; a power source that provides power to the processor when the motor vehicle ignition is on; a seatbelt sensor provided on an occupant seatbelt, the seatbelt sensor in communication with the processor and sensing seatbelt use; an occupant sensor provided at the occupant seating position associated with the seatbelt, the occupant sensor in communication with the processor and sensing the presence of an occupant; and a headlight interface in communication with the processor and headlights of the motor vehicle. The processor further comprises instructions for causing the headlight interface to cause intermittent operation of the headlights when the occupant sensor senses the presence of an occupant without the associated seatbelt sensor sensing seatbelt use. Preferably, the seatbelt sensor and occupant sensor are provided at each occupant seating position in the motor vehicle. In one variation, the external seatbelt usage indication system further comprises a taillight interface in communication with the processor and taillights of the motor vehicle. In this embodiment, the processor comprises instructions for causing the taillight interface to cause intermittent operation of the taillights when the occupant sensor senses the presence of an occupant without the associated seatbelt sensor sensing seatbelt use.

In addition to simple flashing of the headlights, the intermittent operation of the headlights can provide alternate activation of left and right headlights or alternate activation of lowbeams and highbeams. Similarly, in addition to simple flashing of the taillights, the intermittent operation of the taillights can provide alternate activation of left and right taillights.

In variations on the embodiment, the occupant sensor can comprise a weight sensor that senses weight of an occupant at the seating location, the seatbelt sensor can comprise a limit switch that is activated by operation of the seatbelt latch, the instructions for causing the headlight interface to cause intermittent operation of the headlights can provide the intermittent operation for predetermined intervals of time, and the components of the system can be provided in an aftermarket kit.

Another embodiment is to external seatbelt usage indication method for a motor vehicle, comprising providing power to a processor when the motor vehicle ignition is on; sensing an occupant for a seating position and sending a sensed-occupant signal indicating a sensed occupant to the processor; sensing seatbelt use at the seating position and sending a seatbelt-use signal indicating sensed seatbelt use to the processor; determining at the processor a non-usage condition indicated by the presence of a sensed-occupant signal with the absence of a seatbelt-use signal for the seating position; and activating a headlight interface to cause intermittent operation of the headlights for a duration of the non-usage condition. Preferably, the sensing of the occupant and seatbelt use are provided at each occupant seating position in the motor vehicle. In one variation, the method includes activating a taillight interface to cause intermittent operation of the taillights for a duration of the non-usage condition.

In other variations of this embodiment, the intermittent operation of the headlights can comprise alternate activation of left and right headlights or alternate activation of lowbeams and highbeams. Similarly, the intermittent operation of the taillights can comprise alternate activation of left and right taillights.

In yet other variations on the method embodiment, sensing the occupant can comprise a weight sensor sensing weight of an occupant at the seating location, the sensing of seatbelt use can comprise a limit switch being activated by operation of a seatbelt latch, the intermittent operation of the headlights can occur for predetermined intervals of time, and components used in the method can be provided in an aftermarket kit.

An external seatbelt usage indication system and method have been described. It will be understood by those skilled in the art that the invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, e.g., using the articles “a,” “an,” or “the” is not to be construed as limiting the element to the singular.

What is claimed is:

1. An external seatbelt usage indication system for a motor vehicle, comprising
a processor;
a power source for providing power to the processor when the motor vehicle ignition is on;
a seatbelt sensor provided on an occupant seatbelt, the seatbelt sensor in communication with the processor and sensing seatbelt use;
an occupant sensor provided at the occupant seating position associated with the seatbelt, the occupant sensor in communication with the processor and sensing the presence of an occupant; and
a headlight interface in communication with the processor and headlights of the motor vehicle;
wherein the processor comprises instructions for causing the headlight interface to cause intermittent operation of the headlights when the occupant sensor senses the presence of an occupant without the associated seatbelt sensor sensing seatbelt use.

2. The external seatbelt usage indication system for a motor vehicle of claim 1, wherein the seatbelt sensor and occupant sensor are provided at each occupant seating position in the motor vehicle.

3. The external seatbelt usage indication system for a motor vehicle of claim 1, further comprising:
a taillight interface in communication with the processor and taillights of the motor vehicle;
wherein the processor comprises instructions for causing the taillight interface to cause intermittent operation of the taillights when the occupant sensor senses the presence of an occupant without the associated seatbelt sensor sensing seatbelt use.

4. The external seatbelt usage indication system for a motor vehicle of claim 1, wherein the instructions for causing the headlight interface to cause intermittent operation of the headlights comprises instructions for causing alternate activation of left and right headlights.

5. The external seatbelt usage indication system for a motor vehicle of claim 1, wherein the instructions for causing the headlight interface to cause intermittent operation of the headlights comprises instructions for causing alternate activation of lowbeams and highbeams.

6. The external seatbelt usage indication system for a motor vehicle of claim 3, wherein the instructions for causing the taillight interface to cause intermittent operation of the taillights comprises instructions for causing alternate activation of left and right taillights.

7. The external seatbelt usage indication system for a motor vehicle of claim 1, wherein the occupant sensor comprises a weight sensor that senses weight of an occupant at the seating location.

8. The external seatbelt usage indication system for a motor vehicle of claim 1, wherein the seatbelt sensor comprises a switch that is activated by operation of the seatbelt latch.

9. The external seatbelt usage indication system for a motor vehicle of claim 1, wherein the instructions for causing the headlight interface to cause intermittent operation of the headlights comprises instructions for causing the intermittent operation for predetermined intervals of time.

10. The external seatbelt usage indication system for a motor vehicle of claim 1, wherein components of the system are provided in an aftermarket kit.

11. An external seatbelt usage indication method for a motor vehicle, comprising
providing power to a processor when the motor vehicle ignition is on;
sensing an occupant for a seating position and sending a sensed-occupant signal indicating a sensed occupant to the processor;
sensing seatbelt use at the seating position and sending a seatbelt-use signal indicating sensed seatbelt use to the processor;
determining at the processor a non-usage condition indicated by the presence of a sensed-occupant signal with the absence of a seatbelt-use signal for the seating position; and
activating a headlight interface to cause intermittent operation of the headlights for a duration of the non-usage condition.

12. The external seatbelt usage indication method for a motor vehicle of claim 11, wherein the sensing of the occupant and the sensing of seatbelt use are provided at each occupant seating position in the motor vehicle.

13. The external seatbelt usage indication method for a motor vehicle of claim 11, further comprising:
activating a taillight interface to cause intermittent operation of the taillights for a duration of the non-usage condition.

14. The external seatbelt usage indication method for a motor vehicle of claim 11, wherein the intermittent operation of the headlights comprises alternate activation of left and right headlights.

15. The external seatbelt usage indication method for a motor vehicle of claim 11, wherein the intermittent operation of the headlights comprises alternate activation of lowbeams and highbeams.

16. The external seatbelt usage indication method for a motor vehicle of claim 13, wherein the intermittent operation of the taillights comprises alternate activation of left and right taillights.

17. The external seatbelt usage indication method for a motor vehicle of claim 11, wherein sensing the occupant comprises a weight sensor sensing weight of an occupant at the seating location.

18. The external seatbelt usage indication method for a motor vehicle of claim 11, wherein the sensing of seatbelt use comprises a switch being activated by operation of a seatbelt latch.

19. The external seatbelt usage indication method for a motor vehicle of claim 11, wherein the intermittent operation of the headlights occurs for predetermined intervals of time.

20. The external seatbelt usage indication method for a motor vehicle of claim 11, further comprising providing components used in the method in an aftermarket kit.
